(19) United States
(12) Patent Application Publication
(10) Pub. No.: US 2014/0214424 A1
(43) Pub. Date: Jul. 31, 2014

(54) VEHICLE BASED DETERMINATION OF OCCUPANT AUDIO AND VISUAL INPUT

(71) Applicants: Peng Wang, Beijing (CN); Yimin Zhang, Beijing (CN)

(72) Inventors: Peng Wang, Beijing (CN); Yimin Zhang, Beijing (CN)

(21) Appl. No.: 13/977,541

(22) PCT Filed: Dec. 26, 2011
(86) PCT No.: PCT/CN11/84649

§ 371 Date: Sep. 23, 2013

(51) Int. Cl. G10L 15/06; G06K 9/00

(52) U.S. Cl. CPC G10L 15/063; G06K 9/00288
USPC 704/246

(57) ABSTRACT

Systems, apparatus, articles, and methods are described including operations to receive audio data and visual data from one or more occupants of a vehicle. A determination may be made regarding which of the one or more occupants of the vehicle to associate with the received audio data based at least in part on the received visual data.

### BACKGROUND

Voice-control systems often follow statistically based algorithms with offline training and online recognition. In both academia and industry, speaker recognition (e.g., who is speaking) and speech recognition (e.g., what is being said) have been two active topics. Voice recognition is typically understood as a combination of speaker recognition and speech recognition. Voice recognition may use the learnt aspects of a speaker's voice to determine what is being said. For example, some voice recognition systems may not recognize speech from random speakers very accurately, but may reach high accuracy for individual voices with which the voice recognition system has been trained.

Audio-visual speech recognition has been investigated in academia for decades. The common audio-visual speech recognition consists of face detection, tracking; facial feature location; facial feature representation for visual speech; fusion of audio and visual representations of speech.

Existing speech control systems for In-Vehicle-Infotainment (WI) systems (e.g. OnStar, SYNC, and Nuance) typically rely on acoustic signal processing techniques for speech recognition. Existing speech control systems for In-Vehicle-Infotainment haven't introduced visual signal processing techniques for voice recognition.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is an illustrative diagram of an example In-Vehicle-Infotainment (WI) system;

FIG. 2 is a flow chart illustrating an example voice recognition process;

FIG. 3 is an illustrative diagram of an example In-Vehicle-Infotainment (IVI) in operation;

FIG. 4 illustrates several example images processed during lip tracking;

FIG. 5 is an illustrative diagram of an example system; and

FIG. 6 is an illustrative diagram of an example system, all arranged in accordance with at least some implementations of the present disclosure.

### DETAILED DESCRIPTION

One or more embodiments or implementations are now described with reference to the enclosed figures. While specific configurations and arrangements are discussed, it should be understood that this is done for illustrative purposes only. Persons skilled in the relevant art will recognize that other configurations and arrangements may be employed without departing from the spirit and scope of the description. It will be apparent to those skilled in the relevant art that techniques and/or arrangements described herein may also be employed in a variety of other systems and applications other than what is described herein.

While the following description sets forth various implementations that may be manifested in architectures such system-on-a-chip (SoC) architectures for example, implementation of the techniques and/or arrangements described herein are not restricted to particular architectures and/or computing systems and may be implemented by any architecture and/or computing system for similar purposes. For instance, various architectures employing, for example, multiple integrated circuit (IC) chips and/or packages, and/or various computing devices and/or consumer electronic (CE) devices such as set top boxes, smart phones, etc., may implement the techniques and/or arrangements described herein. Further, while the following description may set forth numerous specific details such as logic implementations, types and interrelationships of system components, logic partitioning/integration choices, etc., claimed subject matter may be practiced without such specific details. In other instances, some material such as, for example, control structures and full software instruction sequences, may not be shown in detail in order not to obscure the material disclosed herein.

The material disclosed herein may be implemented in hardware, firmware, software, or any combination thereof. The material disclosed herein may also be implemented as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

References in the specification to “one implementation”, “an implementation”, “an example implementation”, etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to effect such feature, structure, or characteristic in connection with other implementations whether or not explicitly described herein.

Systems, apparatus, articles, and methods are described below including operations to receive audio data and visual data from one or more occupants of a vehicle. A determination may be made regarding which of the one or more occupants of the vehicle to associate with the received audio data based at least in part on the received visual data. In some examples, lip detection and tracking may be implemented for intelligent voice control in In-Vehicle Infotainment (IVI) systems.

Some IVI systems may perform speech-based recognition control based on a small number of predefined vocabularies. In-vehicle speech recognition systems often have challenges. For example, in-vehicle speech recognition systems often have noisy environment with a signal-noise ratio in the range of five to twenty decibels. Additionally, in-vehicle speech recognition systems often have low cost microphones mounted thirty to one hundred centimeters from the speaker as well.

A more natural user interface might utilize a more natural and/or more robust language 25, processing technology. For example, in some example implementation an IVI system may extract speaker's visual data to enhance a noise-robust voice recognition system. For instance, when more than one user speak out voice commands, it may be useful for the IVI system tell which speaker is speaking and adapt to a user-specific speech recognizer. Similarly, when the driver is making a voice command, it may be useful for the radio volume to be automatically lowered to make the background noise lesser.

As will be described in greater detail below, some example implementation may use lip detection and tracking for speaker recognition (e.g., speaker change detection) and for adaptive user-specific voice recognition. In such an audio-visual voice recognition system, lip reading may rely on the accuracy of lip contour detection and/or tracking. Similarly, accurate lip detection may likewise rely on the robustness of face detection.

As used herein, the term “speaker recognition” may refer to recognition of who is speaking. As used herein, the term “speech recognition” may refer to recognition of what is being said. As used herein, the term “voice recognition” may refer to recognition of what is being said based at least in part on recognition of who is speaking, or, in other words, as a combination of speaker recognition and speech recognition. Audio-visual voice control is generally computational expensive, but may be able to provide higher recognition accuracy than speech recognition alone.

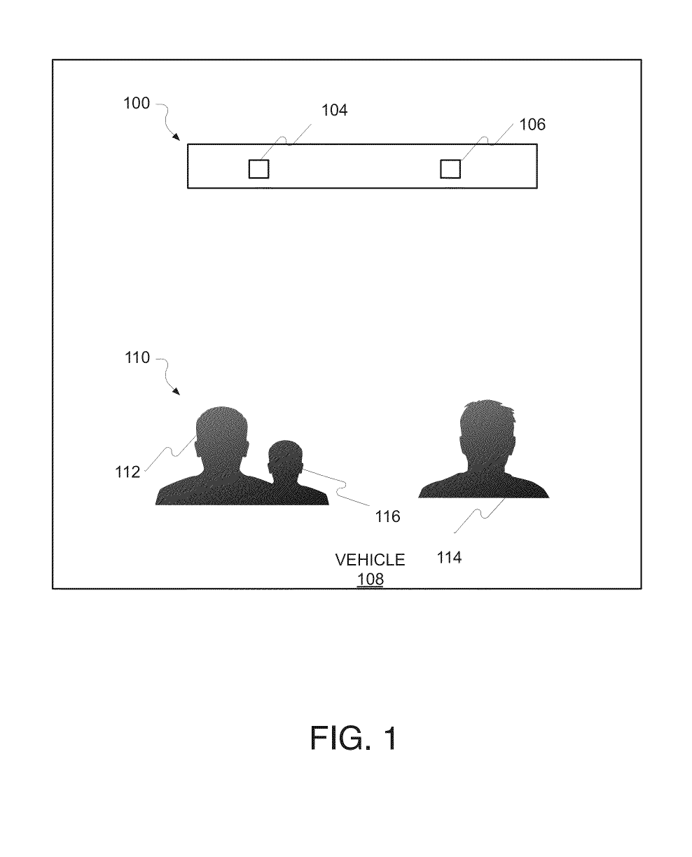

FIG. 1 is an illustrative diagram of an example In-Vehicle-Infotainment (IVI) system 100, arranged in accordance with at least some implementations of the present disclosure. In the illustrated implementation, IVI system 100 may include an imaging device 104 and a microphone device 106. IVI system 100 may be operatively associated with a vehicle 108. For example, IVI system 100 may be located within vehicle 108. In some examples, IVI system 100 may include additional items that have not been shown in FIG. 1 for the sake of clarity. For example, IVI system 100 may include a processor, a radio frequency-type (RF) transceiver, and/or an antenna. Further, IVI system 100 may include additional items such as a speaker, a display, an accelerometer, memory, a router, network interface logic, etc. that have not been shown in FIG. 1 for the sake of clarity.

As used herein, the term “In-Vehicle-Infotainment” may refer to systems located within vehicles that are configured to perform entertainment and/or informational services. In some examples, In-Vehicle-Infotainment may refer to: turn-by-turn navigation, hands-free calling, vehicle diagnostics, emergency services, 911 assist, music search, audible text messages, business search, point-of-interest web search, voice to text messaging, wireless charging, remote monitoring, the like, and/or combinations thereof. Among the above applications, some more specific examples of user interface features that might utilize the voice recognition techniques discussed herein may include: voice control of smartphone applications, voice-activated navigation system, a combination of voice control and touch screen access, voice commands, Bluetooth based voice communication applications, voice-based Facebook applications, voice-based text message while driving, interactive voice responses, the like, and/or combinations thereof.

Imaging device 104 may be configured to capture visual data from one or more occupants 110 of vehicle 108. For example, imaging device 104 may be configured to capture visual data from a driver 112, a front seat passenger 114, from one or more rear seat passenger 116, the like, and/or combinations thereof.

In some examples, visual data of the first user may be captured via a camera sensor or the like (e.g., a complementary metal-oxide-semiconductor-type image sensor (CMOS) or a charge-coupled device-type image sensor (CCD)), without the use of a red-green-blue (RGB) depth camera and/or microphone-array to locate who is speaking. In other examples, an RGB-Depth camera and/or microphone-array might be used in addition to or in the alternative to the camera sensor.

As vehicles are often have a constrained environment, occupant's activity and behavior are typically limited. In particular, occupants are typically seated and usually facing the dashboard when occupants make a command. Therefore, imaging device 104 might include a camera sensor mounted at the rearview mirror position. In such an example, a rearview mirror mounted camera sensor may be able to capture the view of all occupants in the vehicle.

Microphone device 106 may be configured to capture audio data from one or more occupants 110. In some examples, visual data of the first user may be captured without the use of a red-green-blue (RGB) depth camera and/or microphone-array to locate who is speaking. In other examples, an RGB-Depth camera and/or microphone-array might be used in addition to or in the alternative to the camera sensor.

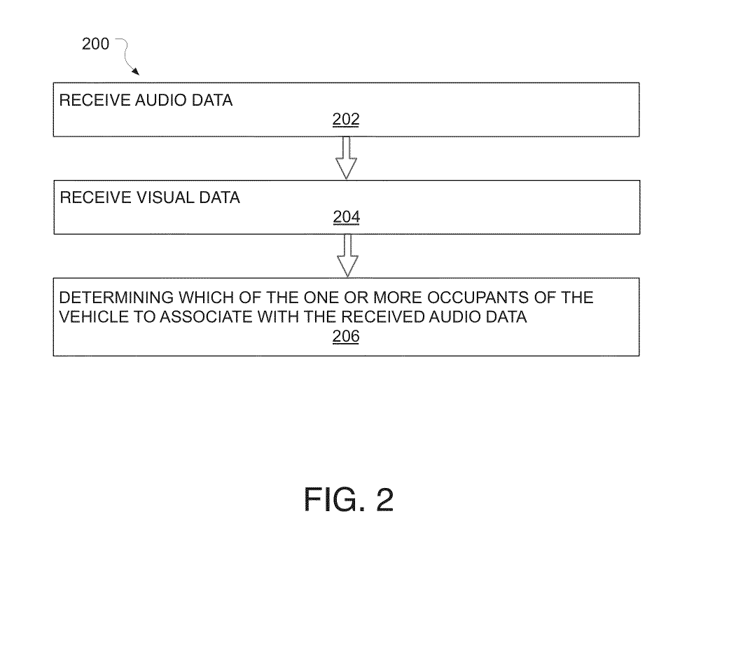

As will be discussed in greater detail below, IVI system 100 may be used to perform some or all of the various functions discussed below in connection with FIGS. 2 and/or 3. For example, IVI system 100 may receive audio data from microphone device 106 and/or visual data from imaging device 104 from one or more occupants 110 of vehicle 108. A determination may be made regarding which of the one or more occupants 110 of vehicle 108 to associate with the received audio data based at least in part on the received visual data.

In operation, IVI system 100 may utilize smart and context aware responses to user verbal inputs. The audio and visual data inputs may be captured by microphone device 106 and imaging device 104 respectively. By combining the audio and visual data, IVI system 100 may be capable of telling one passenger from another in a constrained environment, such as with in a vehicle or other constrained environment. Accordingly, IVI system 100 may be capable of performing smart and robust voice control in In-Vehicle Infotainment systems by leveraging the visual information processing techniques.

FIG. 2 is a flow chart illustrating an example voice recognition process 200, arranged in accordance with at least some implementations of the present disclosure. In the illustrated implementation, process 200 may include one or more operations, functions or actions as illustrated by one or more of blocks 202, 204, and/or 206. By way of non-limiting example, process 200 will be described herein with reference to example In-Vehicle-Infotainment (IVI) system 100 of FIG. 1.

Process 200 may begin at block 202, “RECEIVE AUDIO DATA”, where audio data may be received. For example, the received audio data may include spoken input from one or more occupants of a vehicle.

Processing may continue from operation 202 to operation 204, “RECEIVE VISUAL DATA”, where visual data may be received. For example, the received visual data may include video of the one or more occupants of the vehicle.

Processing may continue from operation 204 to operation 206, “DETERMINE WHICH OF THE ONE OR MORE OCCUPANTS OF THE VEHICLE TO ASSOCIATE WITH THE RECEIVED AUDIO DATA”, where which of the one or more occupants of the vehicle to associate with the received audio data may be determined. For example, which of the one or more occupants of the vehicle to associate with the received audio data may be determined based at least in part on the received visual data.

In operation, process 200 may utilize smart and context aware responses to user verbal inputs. By combining the audio and visual data, process 200 may be capable of telling one passenger from another in a constrained environment, such as with in a vehicle or other constrained environment. Accordingly, process 200 may be capable of performing smart and robust voice control in In-Vehicle Infotainment systems by leveraging the visual information processing techniques.

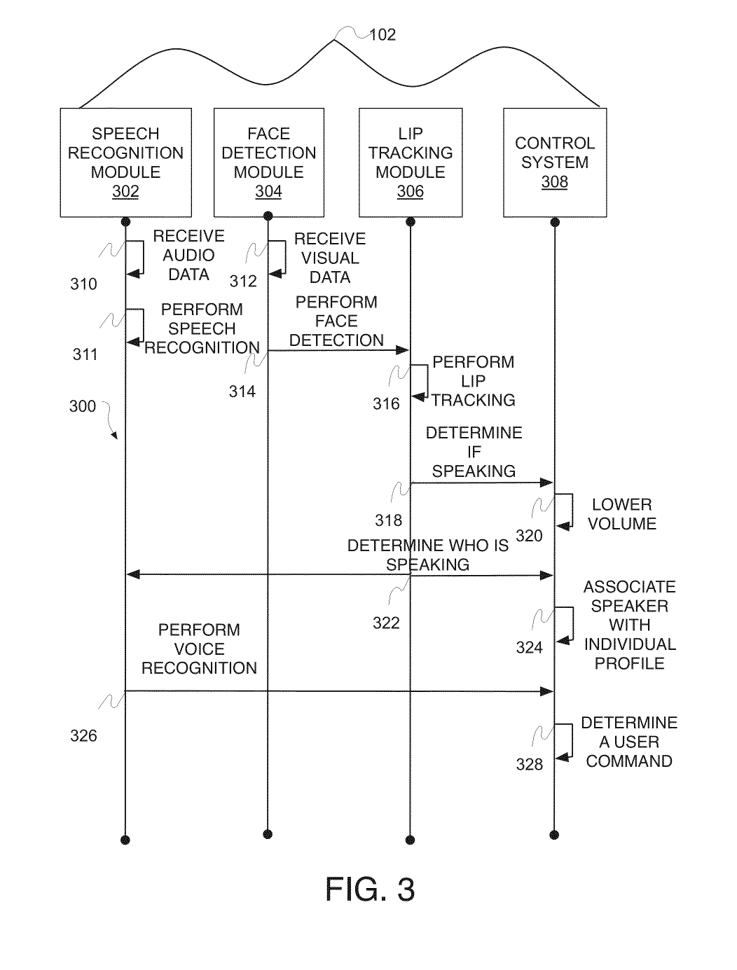

Some additional and/or alternative details related to process 200 may be illustrated in one or more examples of implementations discussed in greater detail below with regard to FIG. 3.

FIG. 3 is an illustrative diagram of example In-Vehicle-Infotainment (IVI) 100 and voice recognition process 300 in operation, arranged in accordance with at least some implementations of the present disclosure. In the illustrated implementation, process 300 may include one or more operations, functions or actions as illustrated by one or more of actions 310, 311, 312, 314, 316, 318, 320, 322, 324, 326, and/or 328. By way of non-limiting example, process 200 will be described herein with reference to example In-Vehicle-Infotainment (IVI) system 100 of FIGS. 1.

In the illustrated implementation, IVI system 100 may include a speech recognition module 302, a face detection module 304, a lip tracking module 306, a control system 308, the like, and/or combinations thereof. As illustrated, speech recognition module 302, face detection module 304, and lip tracking module 306 may be capable of communication with one another and/or communication with control system 308. Although IVI system 100, as shown in FIG. 3, may include one particular set of blocks or actions associated with particular modules, these blocks or actions may be associated with different modules than the particular module illustrated here.

Process 300 may provide an enhanced voice control method, which may combine audio and visual processing techniques to deal with in-vehicle noises and/or speaker adaption problems. In-vehicle noises come from engine, road, in-car entertainment sound, etc. In addition to acoustic signal processing techniques to recognize what command a driver or passenger is issuing, process 300, also may employ visual information processing techniques such as face detection and lip tracking. Such visual information processing techniques may improve the robustness of command recognition under various noise environments.

Process 300 may begin at block 310, “RECEIVE AUDIO DATA”, where audio data may be received. For example, the audio data may be received via speech recognition module 302. The audio data may include spoken input from one or more occupants of a vehicle.

Processing may continue from operation 310 to operation 311, “PERFORM SPEECH RECOGNITION”, where speech recognition may be performed. For example, the speech recognition may be performed via speech recognition module 302. In some examples, such speech recognition may be performed based at least in part on the received audio data.

It is important to understand that the audio data stream is rarely pristine. For example, the audio data stream may contain not only the speech data (e.g., what was said) but also background noises. This noise can interfere with the recognition process, and speech recognition module 302 may handle (and even adapt to) the environment within which the audio is spoken.

Speech recognition module 302 has a rather complex task to handle, that of taking raw audio input and translating it to recognized text that an application understands. In some implementations speech recognition module 302 may utilize one or more language grammar models and/or an acoustic model to return recognized text from audio data input form occupants of the vehicle. For example, speech recognition module 302 may utilize one or more language grammar models to convert spoken audio data input into text. Such language grammar models may employ all sorts of data, statistics, and/or software algorithms to take into consideration the words and phrases known about the active grammars. Similarly, the knowledge of the environment is provided in the form of an acoustic model to speech recognition module 302.

Once speech recognition module 302 identifies the most likely match for what was said, speech recognition module 302 may returns what is recognized as an initial text string. Once the spoken audio data is in the proper format of an initial text string, speech recognition module 302 may search for the best match for an output text string. Speech recognition module 302 may try very hard to find a match for the output text string, and may very be forgiving (e.g., may typically provide a best guess based on a relatively poor quality initial text string).

As will be discussed in greater detail below, the determination of which of the one or more occupants of the vehicle to associate with the received audio data may include several operations. In the illustrated example, such operations may include face detection in conjunction with lip tracking.

Processing may continue from operation 311 to operation 312, “RECEIVE VISUAL DATA”, where visual data may be received. For example, the visual data may be received via face detection module 304. The received visual data may include video of the one or more occupants of the vehicle.

Processing may continue from operation 312 to operation 314, “PERFORM FACE DETECTION”, where a face of an occupant may be detected. For example, the face of the one or more occupants of the vehicle may be detected, via face detection module 304, based at least in part on visual data. In some examples, such face detection may be configured to differentiate between the one or more occupants of the vehicle.

In some examples, the detection of the face may include detecting the face based at least in part on a Viola-Jones-type framework (see, e.g., Paul Viola, Michael Jones, Rapid Object Detection using a Boosted Cascade of Simple Features, CVPR 2001 and/or PCT/CN2010/000997, by Yangzhou Du, Qiang Li, entitled TECHNIQUES FOR FACE DETECTION AND TRACKING, filed Dec. 10, 2010). Such facial detection techniques may allow relative accumulations to include face detection, landmark detection, face alignment, smile/blink/gender/age detection, face recognition, detecting two or more faces, and/or the like.

A Viola-Jones-type framework is one such approach to real-time object detection. The training may be relatively slow, but the detection may be relatively fast. Such a Viola-Jones-type framework may utilize integral images for fast feature evaluation, boosting for feature selection, attentional cascade for fast rejection of non-face windows.

For example, face detection may include sliding a window across an image and evaluating a face model at every location. Faces are typically rare in images, while a sliding window detector may evaluate tens of thousands of location/scale combinations during a face detection task. For computational efficiency, as little time as possible may be spent on non-face windows. A megapixel image has about one hundred and six pixels and a comparable number of candidate face locations. To avoid having a false positive in every image, a false positive rate may be less than ten to six.

Processing may continue from operation 314 to operation 316, “PERFORM LIP TRACKING”, where lip tracking may be performed. For example, lip tracking of the one or more occupants of the vehicle may be performed via lip tracking module 306. In some examples, lip tracking may be performed based at least in part on the received visual data and the performed face detection;

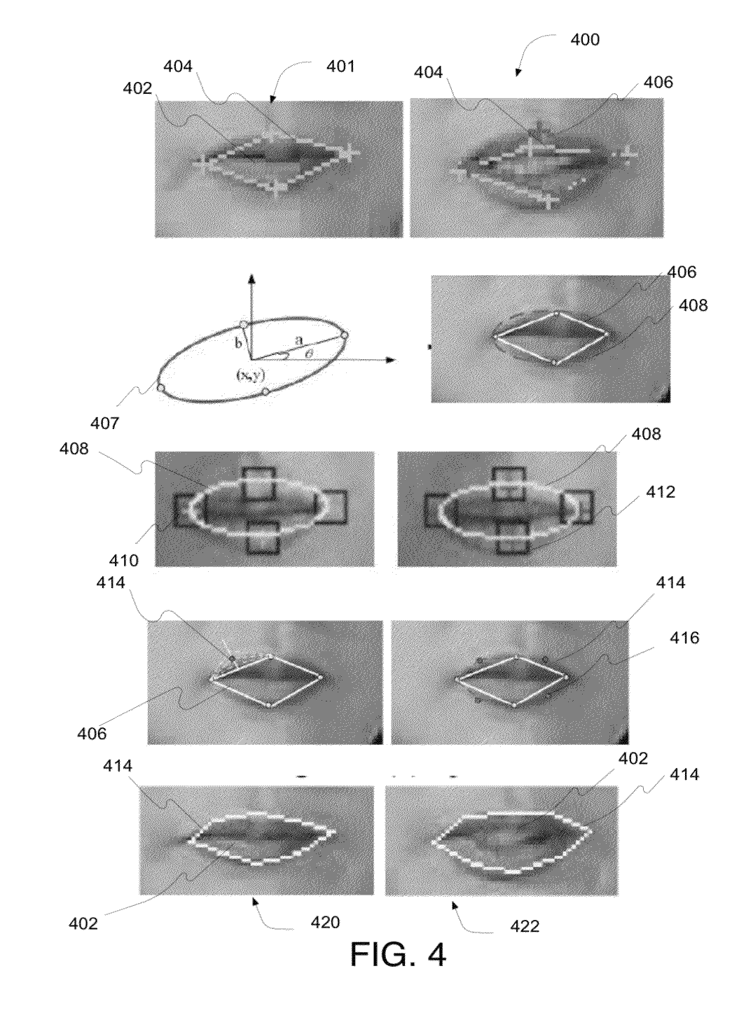

Additional details regarding one example implementation of lip tracking is discussed in greater detail below at FIG. 4.

Processing may continue from operation 316 to operation 318, “DETERMINE IF SPEAKING”, where whether any the one or more occupants of the vehicle are speaking may be determined. For example, whether any the one or more occupants of the vehicle are speaking may be determined via lip tracking module 306. In some examples, a determination of whether any the one or more occupants of the vehicle are speaking may be based at least in part on the lip tracking.

Processing may continue from operation 318 to operation 320, “LOWER VOLUME”, where the volume of the vehicle audio output may be lowered. For example, the volume of the vehicle audio output may be lowered via control system 308. In some examples, the volume of the vehicle audio output may be lowered based at least in part on the determination of whether any the one or more occupants of the vehicle is speaking.

For instance, the engine noise in driving, the background music disturbance from radio listening, and/or multiple speaking occupants will often lower down the accuracy of speech recognition. When audio data itself can't be helpful to improve the accuracy of voice control, visual data could be a complementary cue for IVI system 100 to interact with a vehicle occupant. In some examples, the volume of the vehicle audio output may be lowered based at least in part on the determination of whether any the one or more occupants of the vehicle is speaking.

Processing may continue from operation 320 to operation 322, “DETERMINE WHO IS SPEAKING”, where which of the one or more occupants of the vehicle is speaking may be determined. For example, which of the one or more occupants of the vehicle is speaking may be determined via lip tracking module 306. In some examples, such a determination of which of the one or more occupants of the vehicle is speaking may be based at least in part on the lip tracking.

Processing may continue from operation 322 to operation 324, “ASSOCIATE SPEAKER WITH INDIVIDUAL PROFILE”, where the one or more occupants of the vehicle may be associated with an individual profile. For example, the one or more occupants of the vehicle may be associated, via control system 306, with an individual profile. In some examples, the one or more occupants of the vehicle may be associated with an individual profile based at least in part on the face detection and based at least in part on the determination of which occupant is speaking.

As used herein, the term “individual profile” may include control information relevant to individual occupants, such as occupant identification, control system preferences, or the like. For example, control system 308 may respond to commands or preemptively adjust settings based at least in part on such individual profiles upon receiving data indicating that such an individual is located in the vehicle, or upon receiving data indication that such an individual is speaking or has delivered a command.

For example, with a robust face detection module 304, IVI system 100 could automatically tell the identity of who is speaking then perform personalized settings IVI system 100. In some examples, when a face is detected and recognized, control system 308 might be adapted to adjust control settings based at least in part on the identity of the recognized occupant. Additionally or alternatively, when a face is detected and recognized, control system 308 might adapt any response to a command to adjust the response based at least in part on the identity of the recognized occupant. Additionally, a determination of who is speaking of operation 322 may be communicated to control system 308. In such an example, when a face is detected and recognized and determination is made that this individual is speaking, control system 308 might be adapted to adjust control settings and/or adjust a response to occupant commands based at least in part on the identity of the recognized occupant.

Processing may continue from operation 324 to operation 326, “PERFORM VOICE RECOGNITION”, where voice recognition may be performed. For example, voice recognition may be performed via speech recognition module 302. In some examples, voice recognition may be based at least in part on the performed speech recognition and the determination of which of the one or more occupants of the vehicle is associate with the received audio data.

In some example, such voice recognition may be performed as a modification of speech recognition of operation 311. Alternatively, such voice recognition may be performed independently or as a replacement for speech recognition of operation 311.

In some examples, when a face is detected and recognized, speech recognition module 302 might be adapted to a specific speaker model based at least in part on the identity of the recognized occupant. For example, speech recognition module 302 might be adapted to adjust to various inputs (for instance, using a specific recognizer which is offline trained in advance for the specific occupant, such as the driver and/or a small number of occupants). Additionally, a determination of who is speaking of operation 322 may be communicated to speech recognition module 302. In such an example, when a face is detected and recognized and determination is made that this individual is speaking, speech recognition module 302 might be adapted to a specific speaker model based at least in part on the identity of the recognized occupant.

Processing may continue from operation 326 to operation 328, “DETERMINE A USER COMMAND”, where a user command may be determined. For example, a user command may be determined via control system 308. Such a determination of a user command may be based at least in part on the performed speech recognition and/or voice recognition.

In operation, IVI system 100 may utilize smart and context aware responses to user verbal inputs. The audio and visual data inputs may be captured by microphone and camera respectively. In the audio data processing thread, speech recognition module 302 may to tell what is being said word by word. In the visual data processing thread (e.g., face detection module 304 and/or lip tracking module 306), face detection module 304 may tell the position, size and number of face(s) in the camera image. When a face is detected, the lip area may be further located and tracked in motion pictures via lip tracking module 306. With facial recognition and lip tracking, control system 308 may be able to tell who is in the car and if he/she is speaking right now. By combining the audio and visual data, control system 308 may monitor the speaker change and the command input status.

In some implementations, the visual processing modules (e.g., face detection module 304 and/or the lip tracking module 306) may achieve more than just assisting in the voice recognition. For example, with a robust face detection module 304, IVI system 100 could automatically tell the identity of who is speaking then perform personalized settings IVI system 100. Further, when a face is detected and recognized, speech recognition module 302 might be adapted to a specific speaker model based at least in part on the identity of the recognized occupant. In addition to that, with stable lip tracking module, 306 system 100 could automatically tell the status of if someone is speaking, and then perform positive acoustic environment settings such as lower down the radio volume, or the like. In another example, when lip tracking output is positive, IVI system 100 volume might be lowered down in a smart way.

While implementation of example processes 200 and 300, as illustrated in FIGS. 2 and 3, may include the undertaking of all blocks shown in the order illustrated, the present disclosure is not limited in this regard and, in various examples, implementation of processes 200 and 300 may include the undertaking only a subset of the blocks shown and/or in a different order than illustrated.

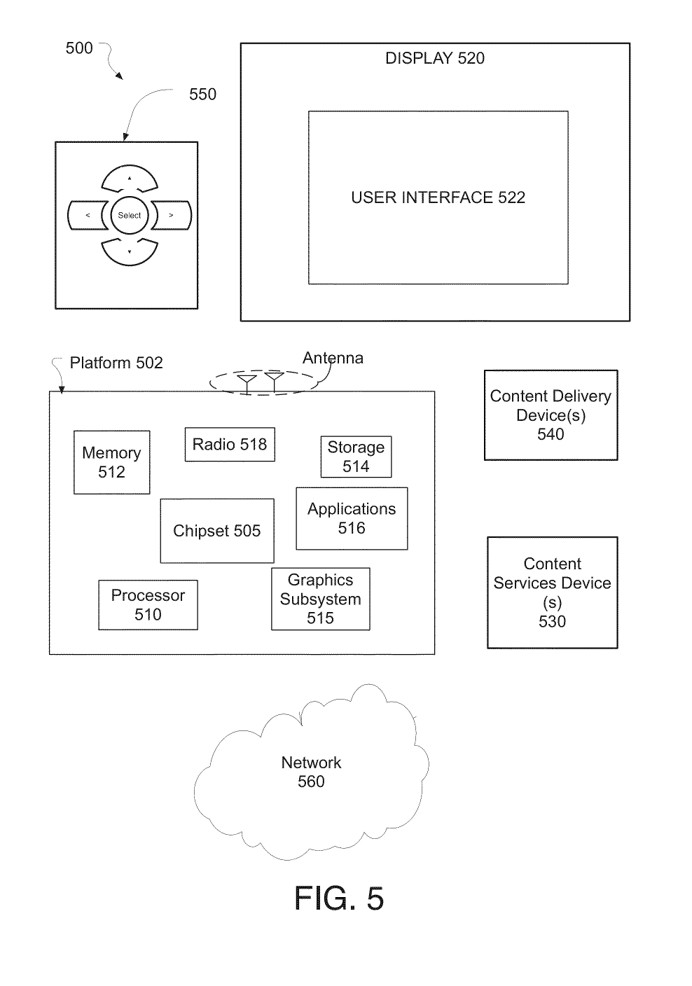

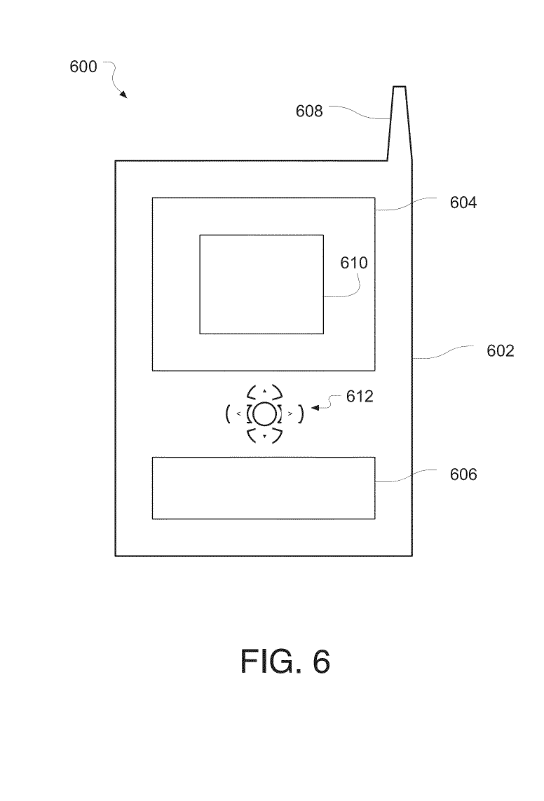

In addition, any one or more of the blocks of FIGS. 2 and 3 may be undertaken in response to instructions provided by one or more computer program products. Such program products may include signal bearing media providing instructions that, when executed by, for example, a processor, may provide the functionality described herein. The computer program products may be provided in any form of computer readable medium. Thus, for example, a processor including one or more processor core(s) may undertake one or more of the blocks shown in FIGS. 5 and 6 in response to instructions conveyed to the processor by a computer readable medium.

As used in any implementation described herein, the term “module” refers to any combination of software, firmware and/or hardware configured to provide the functionality described herein. The software may be embodied as a software package, code and/or instruction set or instructions, and “hardware”, as used in any implementation described herein, may include, for example, singly or in any combination, hardwired circuitry, programmable circuitry, state machine circuitry, and/or firmware that stores instructions executed by programmable circuitry. The modules may, collectively or individually, be embodied as circuitry that forms part of a larger system, for example, an integrated circuit (IC), system on-chip (SoC), and so forth.

FIG. 4 illustrates several example images processed during lip tracking process 400, arranged in accordance with at least some implementations of the present disclosure. As discussed above, some example implementation may use lip detection and tracking for speaker recognition (e.g., speaker change detection) and for adaptive user-specific voice recognition.

The challenges in lip localization and tracking exist in several aspects. For example, deformable object models may be complex, some face poses and/or lip shapes may not be well known or well studied, illumination conditions may be subject to frequent change, backgrounds may be complex and/or may be subject to frequent change, lip movement together with head movement may change position frequently or in an unpredicted manner, and/or other factors, such as self-occlusion.

In the illustrated implementation, lip tracking process 400 may rely on the accuracy of lip contour detection and/or tracking. Similarly, accurate lip, detection may likewise rely on the robustness of face detection. For example, lip tracking process 400 may rely on motion based lip tracking and on optimization based segmentation.

In the illustrated implementation, video data image 401 may be processed so that lips 402 may be detected. The motion based lip tracking portion of lip tracking process 400 may follow three steps: feature points initialization, optical flow tracking, and/or feature points refinement, or the like. For example, four feature points may be initialized by Hierarchical Direct Appearance Model (HDAM) and then a pyramid Lucas-Kanade optical flow method could help to track on sparse feature sets. For example, a feature points initialization operation of lip tracking process 400 may include lip localization 404. Feature point refinement 406 may then revise lip localization 404. For example, feature point positions of feature point refinement 406 may be refined by color histogram comparison and/or local search, as illustrated.

Lip tracking process 400 may include elliptical modeling 407 of the lip contour. Through lip tracking process 400, the lip contour may be represented in an elliptical model 408. As lips are often symmetric, the lip contour may be constructed by first identifying the left/right mouth corners 410, then the top/bottom edge points 412, as illustrated.

Lip tracking process 400 may include lip contour construction 414 by locally searching the mouth edge of lips 402. For example, four or more points 416 may be located, and lip contour 414 may be constructed by locally searching the mouth edge, as illustrated.

Lip tracking process 400 may include tracking lip contour construction 414 results on motion pictures as lips 402 move. For example, video data image 420 illustrates lip tracking process 400 tracking lip contour construction 414 results as lips 402 close. Similarly, video data image 422 illustrates lip tracking process 400 tracking lip contour construction 414 results as lips 402 close. By tracking lip contour construction 414, lip tracking process 400 may be able to tell if a vehicle occupant is speaking or not.

FIG. 5 illustrates an example system 500 in accordance with the present disclosure. In various implementations, system 500 may be a media system although system 500 is not limited to this context. For example, system 500 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In various implementations, system 500 includes a platform 502 coupled to a display 520. Platform 502 may receive content from a content device such as content services device(s) 530 or content delivery device(s) 540 or other similar content sources. A navigation controller 550 including one or more navigation features may be used to interact with, for example, platform 502 and/or display 520. Each of these components is described in greater detail below.

In various implementations, platform 502 may include any combination of a chipset 505, processor 510, memory 512, storage 514, graphics subsystem 515, applications 516 and/or radio 518. Chipset 505 may provide intercommunication among processor 510, memory 512, storage 514, graphics subsystem 515, applications 516 and/or radio 518. For example, chipset 505 may include a storage adapter (not depicted) capable of providing intercommunication with storage 514.

Processor 510 may be implemented as a Complex Instruction Set Computer (CISC) or Reduced Instruction Set Computer (RISC) processors; x86 instruction set compatible processors, multi-core, or any other microprocessor or central processing unit (CPU). In various implementations, processor 510 may be dual-core processor(s), dual-core mobile processor(s), and so forth.

Memory 512 may be implemented as a volatile memory device such as, but not limited to, a Random Access Memory (RAM), Dynamic Random Access Memory (DRAM), or Static RAM (SRAM).

Storage 514 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 514 may include technology to increase the storage performance enhanced protection for valuable digital media when multiple hard drives are included, for example.

Graphics subsystem 515 may perform processing of images such as still or video for display. Graphics subsystem 515 may be a graphics processing unit (GPU) or a visual processing unit (VPU), for example. An analog or digital interface may be used to communicatively couple graphics subsystem 515 and display 520. For example, the interface may be any of a High-Definition Multimedia Interface, DisplayPort, wireless HDMI, and/or wireless HD compliant techniques. Graphics subsystem 515 may be integrated into processor 510 or chipset 505. In some implementations, graphics subsystem 515 may be a stand-alone card communicatively coupled to chipset 505.

The graphics and/or video processing techniques described herein may be implemented in various hardware architectures. For example, graphics and/or video functionality may be integrated within a chipset. Alternatively, a discrete graphics and/or video processor may be used. As still another implementation, the graphics and/or video functions may be provided by a general purpose processor, including a multi-core processor. In further embodiments, the functions may be implemented in a consumer electronics device.

Radio 518 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), cellular networks, and satellite networks. In communicating across such networks, radio 518 may operate in accordance with one or more applicable standards in any version.

In various implementations, display 520 may include any television type monitor or display. Display 520 may include, for example, a computer display screen, touch screen display, video monitor, television-like device, and/or a television. Display 520 may be digital and/or analog. In various implementations, display 520 may be a holographic display. Also, display 520 may be a transparent surface that may receive a visual projection. Such projections may convey various forms of information, images, and/or objects. For example, such projections may be a visual overlay for a mobile augmented reality (MAR) application. Under the control of one or more software applications 516, platform 502 may display user interface 522 on display 520.

In various implementations, content services device(s) 530 may be hosted by any national, international and/or independent service and thus accessible to platform 502 via the Internet, for example. Content services device(s) 530 may be coupled to platform 502 and/or to display 520. Platform 502 and/or content services device(s) 530 may be coupled to a network 560 to communicate (e.g., send and/or receive) media information to and from network 560. Content delivery device(s) 540 also may be coupled to platform 502 and/or to display 520.

In various implementations, content services device(s) 530 may include a cable television box, personal computer, network, telephone, Internet enabled devices or appliance capable of delivering digital information and/or content, and any other similar device capable of unidirectionally or bidirectionally communicating content between content providers and platform 502 and/display 520, via network 560 or directly. It will be appreciated that the content may be communicated unidirectionally and/or bidirectionally to and from any one of the components in system 500 and a content provider via network 560. Examples of content may include any media information including, for example, video, music, medical and gaming information, and so forth.

Content services device(s) 530 may receive content such as cable television programming including media information, digital information, and/or other content. Examples of content providers may include any cable or satellite television or radio or Internet content providers. The provided examples are not meant to limit implementations in accordance with the present disclosure in any way.

In various implementations, platform 502 may receive control signals from navigation controller 550 having one or more navigation features. The navigation features of controller 550 may be used to interact with user interface 522, for example. In embodiments, navigation controller 550 may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 550 may be replicated on a display (e.g., display 520) by movements of a pointer, cursor, focus ring, or other visual indicators displayed on the display. For example, under the control of software applications 516, the navigation features located on navigation controller 550 may be mapped to virtual navigation features displayed on user interface 522, for example. In embodiments, controller 550 may not be a separate component but may be integrated into platform 502 and/or display 520. The present disclosure, however, is not limited to the elements or in the context shown or described herein.

In various implementations, drivers (not shown) may include technology to enable users to instantly turn on and off platform 502 like a television with the touch of a button after initial boot-up, when enabled, for example. Program logic may allow platform 502 to stream content to media adaptors or other content services device(s) 530 or content delivery device(s) 540 even when the platform is turned “off.” In addition, chipset 505 may include hardware and/or software support for 5.1 surround sound audio and/or high definition 7.1 surround sound audio, for example. Drivers may include a graphics driver for integrated graphics platforms. In embodiments, the graphics driver may comprise a peripheral component interconnect (PCI) Express graphics card.

In various implementations, any one or more of the components shown in system 500 may be integrated. For example, platform 502 and content services device(s) 530 may be integrated, or platform 502 and content delivery device(s) 540 may be integrated, or platform 502, content services device(s) 530, and content delivery device(s) 540 may be integrated, for example. In various embodiments, platform 502 and display 520 may be an integrated unit. Display 520 and content service device(s) 530 may be integrated, or display 520 and content delivery device(s) 540 may be integrated, for example. These examples are not meant to limit the present disclosure.

In various embodiments, system 500 may be implemented as a wireless system, a wired system, or a combination of both. When implemented as a wireless system, system 500 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 500 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 502 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 5.

As described above, system 500 may be embodied in varying physical styles or form factors. FIG. 6 illustrates implementations of a small form factor device 600 in which system 500 may be embodied. In embodiments, for example, device 600 may be implemented as a mobile computing device having wireless capabilities. A mobile computing device may refer to any device having a processing system and a mobile power, source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile interne device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In various embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 6, device 600 may include a housing 602, a display 604, an input/output (I/O) device 606, and an antenna 608. Device 600 also may include navigation features 612. Display 604 may include any suitable display unit for displaying information appropriate for a mobile computing device. I/O device 606 may include any suitable I/O device for entering information into a mobile computing device. Examples for I/O device 606 may include an alphanumeric keyboard, a numeric keypad, a touch pad, input keys, buttons, switches, rocker switches, microphones, speakers, voice recognition device and software, and so forth. Information also may be entered into device 600 by way of microphone (not shown). Such information may be digitized by a voice recognition device (not shown). The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

1.-30. (canceled)

31. A computer-implemented method, comprising:
receiving audio data, wherein the audio data includes spoken input from one or more occupants of a vehicle;
receiving visual data, wherein the visual data includes video of the one or more occupants of the vehicle; and
determining which of the one or more occupants of the vehicle to associate with the received audio data based at least in part on the received visual data.

32. The method of claim 31, further comprising:
performing speech recognition based at least in part on the received audio data; and
performing voice recognition based at least in part on the performed speech recognition and the determination of which of the one or more occupants of the vehicle is associate with the received audio data.

33. The method of claim 31, further comprising:
performing speech recognition based at least in part on the received audio data;
performing voice recognition based at least in part on the performed speech recognition and the determination of which of the one or more occupants of the vehicle is associate with the received audio data; and
determining a user command based at least in part on the performed speech recognition.

34. The method of claim 31, wherein the determining which of the one or more occupants of the vehicle to associate with the received audio data further comprises:
performing face detection of the one or more occupants of the vehicle based at least in part on the received visual data, wherein the face detection is configured to differentiate between the one or more occupants of the vehicle.

35. The method of claim 31, wherein the determining which of the one or more occupants of the vehicle to associate with the received audio data further comprises:
performing face detection of the one or more occupants of the vehicle based at least in part on the received visual data, wherein the face detection is configured to differentiate between the one or more occupants of the vehicle; and
associating the one or more occupants of the vehicle with an individual profile based at least in part on the face detection.

36. The method of claim 31, wherein the determining which of the one or more occupants of the vehicle to associate with the received audio data further comprises:
performing lip tracking of the one or more occupants of the vehicle based at least in part on the received visual data.

37. The method of claim 31, wherein the determining which of the one or more occupants of the vehicle to associate with the received audio data further comprises:
associating the one or more occupants of the vehicle with an individual profile based at least in part on the received visual data;
performing lip tracking of the one or more occupants of the vehicle based at least in part on the received visual data;
determining whether any the one or more occupants of the vehicle is speaking based at least in part on the lip tracking; and
lowering volume of vehicle audio output based at least in part on the determination of whether any the one or more occupants of the vehicle is speaking.

38. The method of claim 31, wherein the determining which of the one or more occupants of the vehicle to associate with the received audio data further comprises:
associating the one or more occupants of the vehicle with an individual profile based at least in part on the received visual data;
performing lip tracking of the one or more occupants of the vehicle based at least in part on the received visual data;
determining which of the one or more occupants of the vehicle is speaking based at least in part on the lip tracking; the method further comprising:
performing speech recognition based at least in part on the received audio data; and
performing voice recognition based at least in part on the performed speech recognition and the determination of which of the one or more occupants of the vehicle is associate with the received audio data.

39. The method of claim 31, wherein the determining which of the one or more occupants of the vehicle to associate with the received audio data further comprises:
performing face detection of the one or more occupants of the vehicle based at least in part on the received visual data, wherein the face detection is configured to differentiate between the one or more occupants of the vehicle; and
associating the one or more occupants of the vehicle with an individual profile based at least in part on the face detection;
performing lip tracking of the one or more occupants of the vehicle based at least in part on the received visual data and the performed face detection;
determining whether any the one or more occupants of the vehicle is speaking based at least in part on the lip tracking; and
determining which of the one or more occupants of the vehicle is speaking based at least in part on the lip tracking; the method further comprising
performing speech recognition based at least in part on the received audio data; and
performing voice recognition based at least in part on the performed speech recognition and the determination of which of the one or more occupants of the vehicle is associate with the received audio data; and
determining a user command based at least in part on the performed speech recognition.

40. An article comprising a computer program product having stored therein instructions that, if executed, result in:
receiving audio data, wherein the audio data includes spoken input from one or more occupants of a vehicle;
receiving visual data, wherein the visual data includes video of the one or more occupants of the vehicle; and
determining which of the one or more occupants of the vehicle to associate with the received audio data based at least in part on the received visual data.

41. The article of claim 40, wherein the instructions, if executed, further result in:
performing speech recognition based at least in part on the received audio data;
performing voice recognition based at least in part on the performed speech recognition and the determination of which of the one or more occupants of the vehicle is associate with the received audio data; and
determining a user command based at least in part on the performed speech recognition.

42. The article of claim 40, wherein the determining which of the one or more occupants of the vehicle to associate with the received audio data further comprises:
performing face detection of the one or more occupants of the vehicle based at least in part on the received visual data, wherein the face detection is configured to differentiate between the one or more occupants of the vehicle; and
associating the one or more occupants of the vehicle with an individual profile based at least in part on the face detection.

43. The article of claim 40, wherein the determining which of the one or more occupants of the vehicle to associate with the received audio data further comprises:
associating the one or more occupants of the vehicle with an individual profile based at least in part on the received visual data;
performing lip tracking of the one or more occupants of the vehicle based at least in part on the received visual data;
determining whether any the one or more occupants of the vehicle is speaking based at least in part on the lip tracking; and
lowering volume of vehicle audio output based at least in part on the determination of whether any the one or more occupants of the vehicle is speaking.

44. The article of claim 40, wherein the determining which of the one or more occupants of the vehicle to associate with the received audio data further comprises:
associating the one or more occupants of the vehicle with an individual profile based at least in part on the received visual data;
performing lip tracking of the one or more occupants of the vehicle based at least in part on the received visual data;
determining which of the one or more occupants of the vehicle is speaking based at least in part on the lip tracking; and wherein the instructions, if executed, further result in:
performing speech recognition based at least in part on the received audio data; and
performing voice recognition based at least in part on the performed speech recognition and the determination of which of the one or more occupants of the vehicle is associate with the received audio data.

45. An apparatus, comprising:
a processor configured to:
receive audio data, wherein the audio data includes spoken input from one or more occupants of a vehicle;
receive visual data, wherein the visual data includes video of the one or more occupants of the vehicle; and
determine which of the one or more occupants of the vehicle to associate with the received audio data based at least in part on the received visual data.

46. The apparatus of claim 45, wherein the processor is further configured to:
perform speech recognition based at least in part on the received audio data;
perform voice recognition based at least in part on the performed speech recognition and the determination of which of the one or more occupants of the vehicle is associate with the received audio data; and
determine a user command based at least in part on the performed speech recognition.

47. The apparatus of claim 45, wherein the determination of which of the one or more occupants of the vehicle to associate with the received audio data further comprises:
perform face detection of the one or more occupants of the vehicle based at least in part on the received visual data, wherein the face detection is configured to differentiate between the one or more occupants of the vehicle; and
associate the one or more occupants of the vehicle with an individual profile based at least in part on the face detection.

48. The apparatus of claim 45, wherein the determination of which of the one or more occupants of the vehicle to associate with the received audio data further comprises:
associate the one or more occupants of the vehicle with an individual profile based at least in part on the received visual data;
perform lip tracking of the one or more occupants of the vehicle based at least in part on the received visual data;
determine whether any the one or more occupants of the vehicle is speaking based at least in part on the lip tracking; and
lower volume of vehicle audio output based at least in part on the determination of whether any the one or more occupants of the vehicle is speaking.

49. The apparatus of claim 45, wherein the determination of which of the one or more occupants of the vehicle to associate with the received audio data further comprises:
associate the one or more occupants of the vehicle with an individual profile based at least in part on the received visual data;
perform lip tracking of the one or more occupants of the vehicle based at least in part on the received visual data;
determine which of the one or more occupants of the vehicle is speaking based at least in part on the lip tracking; and wherein the processor is further configured to:
perform speech recognition based at least in part on the received audio data; and
perform voice recognition based at least in part on the performed speech recognition and the determination of which of the one or more occupants of the vehicle is associate with the received audio data.

50. A system comprising:
an imaging device configured to capture visual data; and
a computing system, wherein the computing system is communicatively coupled to the imaging device, and wherein the computing system is configured to:
receive audio data, wherein the audio data includes spoken input from one or more occupants of a vehicle;
receive the visual data, wherein the visual data includes video of the one or more occupants of the vehicle; and
determine which of the one or more occupants of the vehicle to associate with the received audio data based at least in part on the received visual data.

51. The system of claim 50, wherein the computing system is further configured to:
perform speech recognition based at least in part on the received audio data;
perform voice recognition based at least in part on the performed speech recognition and the determination of which of the one or more occupants of the vehicle is associate with the received audio data; and
determine a user command based at least in part on the performed speech recognition.

52. The system of claim 50, wherein the determination of which of the one or more occupants of the vehicle to associate with the received audio data further comprises:
perform face detection of the one or more occupants of the vehicle based at least in part on the received visual data, wherein the face detection is configured to differentiate between the one or more occupants of the vehicle; and
associate the one or more occupants of the vehicle with an individual profile based at least in part on the face detection.

53. The system of claim 50, wherein the determination of which of the one or more occupants of the vehicle to associate with the received audio data further comprises:
associate the one or more occupants of the vehicle with an individual profile based at least in part on the received visual data;
perform lip tracking of the one or more occupants of the vehicle based at least in part on the received visual data;
determine whether any the one or more occupants of the vehicle is speaking based at least in part on the lip tracking; and
lower volume of vehicle audio output based at least in part on the determination of whether any the one or more occupants of the vehicle is speaking.

54. The system of claim 50, wherein the determination of which of the one or more occupants of the vehicle to associate with the received audio data further comprises:
associate the one or more occupants of the vehicle with an individual profile based at least in part on the received visual data;
perform lip tracking of the one or more occupants of the vehicle based at least in part on the received visual data;
determine which of the one or more occupants of the vehicle is speaking based at least in part on the lip tracking; and wherein the computing system is further configured to:
perform speech recognition based at least in part on the received audio data;
perform voice recognition based at least in part on the performed speech recognition and the determination of which of the one or more occupants of the vehicle is associate with the received audio data.
